(19) United States
(12) Patent Application Publication
(10) Pub. No.: US 2011/0202443 A1
(43) Pub. Date: Aug. 18, 2011

(54) System For Wireless Cybermedia Services

(76) Inventor: Rowland J. Martin, San Antonio, TX (US)

(21) Appl. No.: 13/026,246

(22) Filed: Feb. 12, 2011

Related U.S. Application Data
(60) Provisional application No. 61/337,908, filed on Feb. 12, 2010.

(51) Int. Cl. G06Q 10/00; H04W 4/00; G06Q 30/00

(52) U.S. Cl. 705/34; 370/328

(57) ABSTRACT

A wireless cybermedia system of commerce in communications, comprising a business process and open network management system for syndication, performance and distribution of multimedia content to wireless residential, institutional and educational users; original articles of manufacture specifically including a transceiver device and navigation interfaces for processing network metadata; and a wireless broadband supernetwork apparatus for scalable delivery of internet protocol multimedia services.

### CROSS REFERENCE TO RELATED APPLICATIONS

This application claims the benefit of one pending filing, Patent and Trademark Office provisional patent application No. 61/337/908 filed by Rowland J. Martin on Feb. 12, 2010. The cross referenced application is incorporated into this regular application in its entirety by this reference.

### BACKGROUND

1. Field of the Invention

The invention arises in the field of “multiplexed communications—special services.” It proposes a specialized business model and infrastructure in the 3650 to 3700 MHz spectrum band to reduce socio-economic opportunity costs associated with historical failures to bridge the digital divide, to reduce transaction costs of market entry for wireless broadband service providers, and to promote regulatory flexibility in support of policy Federal Communications Commission (FCC) policy goals including neutrality of network management. See, National Broadband Plan (February 2010), Federal Communications Commission (FCC), and National Telecommunications and Information Administration (U.S. Department of Commerce), “Falling Through the Net: Defining the Digital Divide,” July 1999.

### 2. Description of References

Review of prior art on wireless broadband networks in the 3.65 GHz band reveals that the scope and content of prior art is limited mainly to engineering issues that are distinct from the interdisciplinary array of socio-economic, transactional, scientific and regulatory flexibility issues addressed in this application.

The references on wireless broadband service in the 3650 to 3700 MHz spectrum band that relates to this application consists of U.S. Pat. Nos. 7,660,573, and U.S. Patent Application 210020868, both relating to infrastructure for the operation of wireless telecommunication networks. Other references indirectly relevant to the invention claimed in this application are cited by Elmaleh in U.S. Pat. No. 7,660,573, and patent application 210020868, which is not admitted to be prior art with respect to the present invention by its mention here. A publication noting an increasing number of amateur radio operators who are putting the Internet to work as a bridge for long distance communication and internet radio linking projects. See, American Radio Relay League, “VOIP and Amateur Radio” (2009). The latter source address a method of linking internet radio outlets, but do not support point-to-multipoint communications due to limitations of existing regulations. As such, the latter does not address any realistic means for using the internet to bridge the digital divide.

In contrast, the FCC Report And Order No. 10-201 on network neutrality and network management practices, adopted Dec. 21, 2010, alludes in general terms to infrastructure that is analogous to the state of art reflected in the present invention. In adopting rules on network neutrality, the FCC responded to a need to preserve open network market conditions while encouraging innovation to reverse lack of internet access to under-connected urban and rural communities that has been a problem for many years. The FCC also recognized that the problem still exists because while some legacy carriers appeared to have opted to adopt pricing schemes to compensate for congestion due to high-bandwidth traffic, the wireless internet service provider (WISP) community is still in the preliminary stages of deploying licensed and unlicensed wireless technologies that provide the best chance for low cost access.

The FCC's Net Neutrality Order makes general references to “specialized services” and to “stand alone video programming aggregators that may function as competitive alternatives to traditional Multichannel Video Programming Distributors . . . ” Based on considerations such as these, the Commission took measured steps to protect the openness of the Internet for future innovation by mobile broadband. As the Commission stated, “Mobile broadband is an important Internet Access platform . . . with an eco-system [that] is experiencing very rapid innovation and change, including an expanding array of smartphones, aircard modems, and other devices that allow mobile broadband providers to enable Internet access . . . and the evolution of new business models for mobile broadband providers, including usage based pricing.” FCC Report And Order 10-201, Id. These terms reflect the Commission's understanding that specialized services and innovative internet protocol offerings are an earlier stage platform than fixed broadband, and that wireless broadband service in the 3.65 GHz spectrum band is at an even earlier stage of platform development. As such, the FCC Net Neutrality Order did not contemplate or disclose any specific characteristics of specialized services and programming aggregators that the rules were intended to encourage, or refer to specific characteristics of the invention claimed here.

Lastly, a diligent search of scholarly papers on wireless telecommunications shows numerous references to various mobile television technologies and techniques. These references touch mainly on the engineering aspects of wireless broadband networks. Zhang, et al, “Sender-adaptive and receiver driven layed multicast for scalable video over the Internet,” IEEE Circuits and Systems for Video Technology (April 2005); Tamai, et al, “Transcasting: Cost-Efficient Video Multicast for Heterogenous Mobile Terminals,” (available on-line); Ott, et al, “Networked Multimedia with Internet Media Guides, Computational Methods in Science And technology 11(20, 129-139 (2005); and Epstein, et al, “Mobile Technologies and Creative Tourism,” Proceedings of the Twelfth Americas Conference on Information Systems, Acapulco, Mexico (Aug. 4-6, 2006). As a general matter, the invention is designed to be compatible with, but makes no claim to the subject matter of prior art, such as Wi-Fi™ and its enabling technology; WIMAX™ technology contained in IEEE 802.11 and 802.16; 3GPP2 multimedia file formats discussed in “File Formats for Multimedia Services,” (May 18, 2007); Long Term. Evolution technology for non-line of sight communications; and prior art on Internet Media Guides (IMGs) in Internet Engineering Task Force RFC-4473, “Requirements for Internet Media Guides.” The most comprehensive reference on mobile broadcasting located by this Applicant, “Mobile Broadcasting with WIMAX” Amitabh Kumar, states simply that “The United States has recently opened up the 3.650 to 3.7 GHz band for contention based wireless services to minimize interference with satellite services. A hybrid approach of licensed and unlicensed usage is followed in this band.” Id. at p. 292.

The few references that specifically address the unique scientific challenges of closing the digital divide, or those that address achieving sustainable internet access for the low income communities, on the other hand, do not combine the totality of business modeling specifications for sustainability of adoption and supernetwork operations that are shown in the present application. Compare, Camp, et al. “Developing and Deploying Multihop Wireless Networks for Low-Income Communities,” Technology For All (available through http//www.techforall.org.); James, “Sustainable Internet Access for the rural poor? Elements of an emerging Indian Model,” (Elsevier Science Ltd., 2003); and Merkuria, Mobile Broadband Technology & Services: Sustainability Factors (Pretoria 2008). A search of archives maintained by WISP organizations also reveals no reference to the specifications for wireless cybermedia business process published here. For example, see the FCC's Universal Licensing System, at <<www.fcc.gov>>, and web-sites for the Wireless Internet Service Providers Association (“WISPA”) at <<www.wispa.org>>, the California Internet Service Providers Association at <<www.cispa.net>> and the Minority Telecommunications And Media Council at <<www.mmtc.com>>. In summary, none of these references address the totality of specific socio-economic, transactional and regulatory flexibility elements addressed by the invention here, and none indicate that the methods here are obvious to try. In this regard, none are admitted to be prior art with respect to the present invention by their mention here.

### 3. Background Of The Long Felt Need To Diversify The Telecommunications Marketplace

One major difference between the invention here and the prior art is that the invention supports the FCC's decision on Dec. 21, 2010 to adopt network neutrality rules, and responds to the long and relatively unsuccessful history of efforts to promote diversify ownership and employment in mass communications dating back to the turn of the 20^{th} century. After World War I, Congress enacted the Radio Act of 1927 and later, the Communications Act of 1934. More recently Congress enacted the Telecommunications Act of 1996, and the American Recovery and Reinvestment Act of 2009. Because significant aspects of the 20^{th} century policy goals have not been fully accomplished, the level of skill required to achieve these goals is unknown and quite likely exceeds the engineering expertise reflected in prior art.

The purpose of the 1934 Act was originally to “make available so far as possible to all people of the United States, a rapid, efficient, Nationwide and world wide wire an radio communications service.” Congress passed the 1934 Act after the development of commerce in radio broadcasting exceeded the capacity of then-available technology to avoid interference with competing users. Hammond describes the ensuing fifty years of repeated difficulties faced by the FCC, the broadcast industry, the cable industry, and then-new video distribution services, in accomplishing meaningful diversity of ownership and employment, so as to fulfill the purpose of the 1934 Act. See, Allen Hammond, “Now You See It, Now You Don't: Minority Ownership In An Unregulated Video Marketplace,” Catholic University Law Review, Vol. 32:633 (1983).

According to Hammond, numerous factors contributed to the result that in 1983, “less than 1% of the operating video outlets are minority owned despite the fact that minorities comprise more than 20% of the American population.” Id. at p. 635. Practically all relate to transaction cost factors including complex licensing procedures based on spectrum scarcity, lack of access to venture capital, concentration of media ownership, numerical size and income disparities between audience groups, advertising practices and inaccurate ratings information.

Almost ten years later, the Supreme Court reached the same essential conclusions in its 1990 decision in Metro Broadcasting, Inc. v. FCC, 497 U.S. 547 (1990), where the Court considered the constitutionality of the FCC's ownership diversity policies: [I]t is axiomatic that . . . the widest possible dissemination of information from diverse and antagonistic source is essential to the welfare of the public . . . . Safeguarding the publics right to receive a diversity of views over the airwaves is therefore an integral part of the FCC mission . . . [T]he people as whole retain their interest in free speech by radio [and other forms of broadcast] and their collective right to have the medium function consistently with the ends and purposes of the First Amendment . . . . Against this background, we conclude that the interest in enhancing broadcast diversity is, at the very least, an important governmental objective . . . ” Metro, Id. at Part II-A. The FCC's policies to encourage minority ownership were later dismantled.

In 1993, the United States embarked on a new regulatory regime with the enactment of the Telecommunications Act of 1993, legislation by Congress mandating licensing of non-broadcast spectrum through competitive bidding. The FCC's Small Business Advisory Committee, a group chartered to advise the Commission on policy options for small business, “Rapid deployment of these advanced technologies, without commensurate efforts to promote the diffusion of spectrum use capabilities across economic and geographical lines, however, is unlikely to achieve intended productivity gains . . . . At a time when the pace of technological innovation is increasing at an amazing rate, it is easy to overlook the communications needs of populations the inhabit economically distressed communities in urban and rural areas. Only 20 to 30 percent of U.S. rural households have telephone service. Similarly, ‘[j]ust 81 percent of African American and Hispanic households have telephone service,’ compared to 91 percent of all U.S. Households. In mobile communications, according to 1990 data, there are only about 5.3 million cellular telephone subscribers and 2 million paging service subscribers out of a total estimated market of 96 million. Finally, 40% of the nation's households do not subscribe to cable television.” Interim Report of the Federal Communications Commission Small

### Business Advisory Committee for FY 1993.

Some observers anticipated that communities receiving a low roll-out priority when cable and broadband connections were first deployed would eventually receive improved access commensurate with advances in technology. But even with stunning advances in technology, that did not materialize either. In 2001, Nobel Prize winner Michael Spence reflected on this fact, and the socio-economic and technological aspects of the new digital communications paradigm, by noting that the internet changed the informational structure of many markets, but that almost everyone “underestimated the amount of difficult technical infrastructure that needed to be built in order to have the foreseen outcomes become a reality,” and also “overestimated the speed with which individuals and organizations change their behavior . . . ” Spence, “Signaling In Retrospect And The Information Structure of Markets,” (Nobel Prize Lecture, Dec. 8, 2001), p. 436; see also, see, Hoffman, “The evolution of the digital divide: How Gaps in Internet access may impact electronic commerce,” (Journal of Computer Mediated Communication, 2000); and “From access to outcomes: raising the aspirations for technology initiatives in low-income communities',” (Reston, Va.: Morino Institute, 2001).

The promised benefits of late 20^{th} century advances have clearly not materialized for all Americans at the pace expected. Some communities and households that were supposed to be the beneficiaries of past advances are still disaggregated and under-served by virtue of location and socio-economic conditions, or because they find no compelling need for internet service. According to a 2010 study by the Pew Institute, dial-up users and adults without Internet connectivity most often said they did not have broadband because it was not relevant to them. Fifty percent of those respondents fell into that category, citing reasons such as “not interested” or “too busy.” Nineteen percent of non-broadband users pointed to price, and 17 percent cited availability problems as their reasons for not being connected. Despite an overall upward trend, however, about 9 percent of respondents said they had canceled or cut back on their Internet service as a result of the economy. All these factors contribute to what is known as the digital divide. Martin, “Harness Internet power for people,” San Antonio Express-News, (Sep. 22, 2010).

Factors such as these prompted Congress to mandate a National Broadband Plan and to include stimulus packages for broadband deployment in the American Recovery and Reinvestment Act of 2009. The Recovery Act, like the acts before it, mandates that the FCC must seek to ensure all people of the United States have access to broadband capability. Parallel to broadband incentives in the Recovery, the FCC in 2007 embarked on the most recent paradigm change in licensing methodology by adopting a non-exclusive, lightly licensed spectrum commons scheme for assigning licenses in the 3650 to 3700 spectrum band. See, Memorandum Opinion And Order in “Wireless Operation in the 3650-3700 MHz Band,” FCC 07-99 (June 2007).

The advances in technology during the 20^{th} century make it possible to allocate spectrum for unlicensed uses as well as assign non-exclusive licenses subject to contention based protocols. The FCC's stated technical goal was to provide a new home for emerging advanced wireless technologies, to be shared with incumbent fixed satellite service earth stations, by allowing wireless broadband licensees to pay a small fee for a nation wide, non-exclusive license, and an additional nominal fee for each high powered base station that they deploy. The spectrum common approach was also supposed to encourage multiple entrants and stimulate rapid expansion of broadband services. This action was intended to “facilitate the rapid deployment of advanced telecommunications services and technologies to all Americans. We also believe that the 3650 MHz band provides an ideal setting to build on the current success of WISPs in providing broadband service to users not otherwise served, and to respond to calls by the federal Advisory Committee of diversity for Communications in the Digital Age to increase the opportunity for new entrants, including minorities, in emerging technology sectors of the telecommunications industry.” FCC Report And Order, No. 05-56, “In The Matter of Wireless Operations in the 3650-3700 MHz Band,” FCC (Mar. 16, 2005) at p. 8.

Although intended to alleviate traditional obstacles to diversity, the 3650 MHz scheme poses several new problems. Transaction costs were magnified by the novelty of spectrum commons licensing scheme, uncertainties about the sustainability of wireless broadband adoption, and long term financial instability in the market for venture capital. Another problem arose from the designation of certain metropolitan areas as exclusion zones to avoid interference with adjacent satellite earth station licensees. The licensing scheme requires operators in a common market to resolve spectrum coordination issues voluntarily without FCC intervention, creating uncertainty about the means for resolving local conflicts. Presently, operators use the band mostly to providing interne access in rural areas. This fragmentation complicates the development of nationwide economies of scale to attract commercial funding sources. A significant number of consumers, not to mention creative service providers, advertisers and software developers who target the digital divide segment, are deterred from using this scheme as a means of distributing content to their respective communities, thus further disadvantaging digital divide communities and society at large.

The economic opportunity costs of a 21^{st} century failure to bridge the digital divide cannot be understated. Spence notes that signaling is something one does in part to communicate and that one of the most powerful forces driving outcomes in the informational structure of markets is Metcalfe's law stating that a “network effect” whereby the value of a network to the entities attached to it is proportional to the square of the numbers of the connected signaling parties using it to communicate. In economically distressed American communities, as in many developing countries, “Access to information and telecommunications is essential for development, but is still inadequate or nonexistent . . . . This is a vicious cycle—few potential customers means high price (if cost-based), which further reduces the number of potential customers and so on . . . ” James, Id. at p. 462. Is is said that achieving long-term sustainability is probably the most difficult goal when designing and operating wireless networks in developing countries because there have been few successes with the development of sustainable business models to accomplish that purpose. “Wireless Networking In The Developing World,” 2′^{d} Edition (Hacker Friendly, 2007), at p. 281.

The same observation is true about the scarcity of obvious sustainable business models for developing communities in the United States. The history of 20^{th} century communications policy and business development teaches that engineering advances promoting efficient spectrum use are only one of several elements of an effective communications apparatus and are not likely to diversify ownership without parallel socio-economic, transactional and regulatory flexibility elements to reduce transaction and opportunity costs. Therefore, an urgent need exists for a wireless cybermedia business system and process to optimize service to diversify the telecommunications marketplace and to bridge the digital divide. History teaches that the model most likely to advance diversity is one that combines state of the art science in wireless broadband technology, with parallel non-technical elements appropriate to accommodate cell-phone only communities where the state of the infrastructure is known to be inadequate. Camp, et al, Id. Consequently, there is a distinct possibility that critical socio-economic, transactional and regulatory flexibility features, though being omitted in the disclosed references, have the potential to produce unexpected benefits when combined under the existing licensing scheme with advanced engineering methods that are currently in use.

### BRIEF SUMMARY

The present embodiment of the invention is directed to a business process, articles of manufacture and a wireless broadband supernetwork apparatus. The business process aggregates economies of scale and scope based on a virtualized platform of value added services. Articles of manufacture comprise a wireless transceiver device and software interfaces for users and service providers. A wireless broadband supernetwork apparatus with specialized socio-economic, transactional, scientific, and regulatory flexibility elements delivers internet protocol services from the internet to base station operators, and from base station operators to users, anywhere in the nationwide footprint of the 3650 MHz spectrum band in accordance with open network management principles.

More particularly, the method of the innovation connects a user to the Internet, through access points and base stations operated by service providers, with a device that can be a mobile telephone, set top box, computer or any other suitable communications device. Users open a monthly or prepaid subscriber account, log on using a device, register and establish a user account, create a user profile, execute settings to generate playlist services and subscribe to an internet media guide hosted by the network operator. The innovation uses settings for a decimal-based method for coding, retrieving, storing, and processing metadata that maps user-generated variables and digital identifiers. WISP operators and WiFi hotspot operators can then use this infrastructure, to bundle virtualized VOIP services, multimedia content, and non-carrier programmer services, with their pre-existing interne access offerings. When properly authorized by the user, creative service providers and channel operators can use the profile to resell value-added network multimedia content, and to sell and insert messages purchased by sponsors of commercial advertising.

### BRIEF DESCRIPTION OF THE DRAWINGS

The above features, aspects, and advantages of the present invention will become better understood with regard to the following description and accompanying drawings, wherein:

FIG. 1 is a drawing of a network management software.

FIG. 2 is drawing of a wireless broadband transceiver that is an embodiment of the invention.

FIG. 3 is a drawing of a wireless cybermedia transmission from a network management software to a wireless broadband receiver.

FIG. 4 is a diagram showing a “triple play” application as a service to support wireless broadband to cloud interface users.

FIG. 5 is a diagram showing an IPTV application as a service to support wireless broadband to cloud interface users.

### DETAILED DESCRIPTION

There are three embodiments of the innovation modeled in the descriptions below, carrier, non-carrier and private network services. A single network operator and group owner of fixed stations can perform all three roles or the roles can be performed hierarchially by different fixed station operators. In any case, each platform supports delivery of voice, video and data services. For ease of reference and understanding, the combination of voice, video and data services is commonly known as a “triple play” package. In this case, however, the triple play is bundled with a package of additional IP service channels including learning, radio, television, music, movie, and virtual reality connection services. Regardless of modeling, each level of the platform provides business opportunities for sale of software, wireless base station and access point equipment, and receiver devices. These features create economies of scale and scope sufficient to reduce transaction costs, and ultimately, reducing opportunity costs of internet underutilization.

### 1. The Business Process

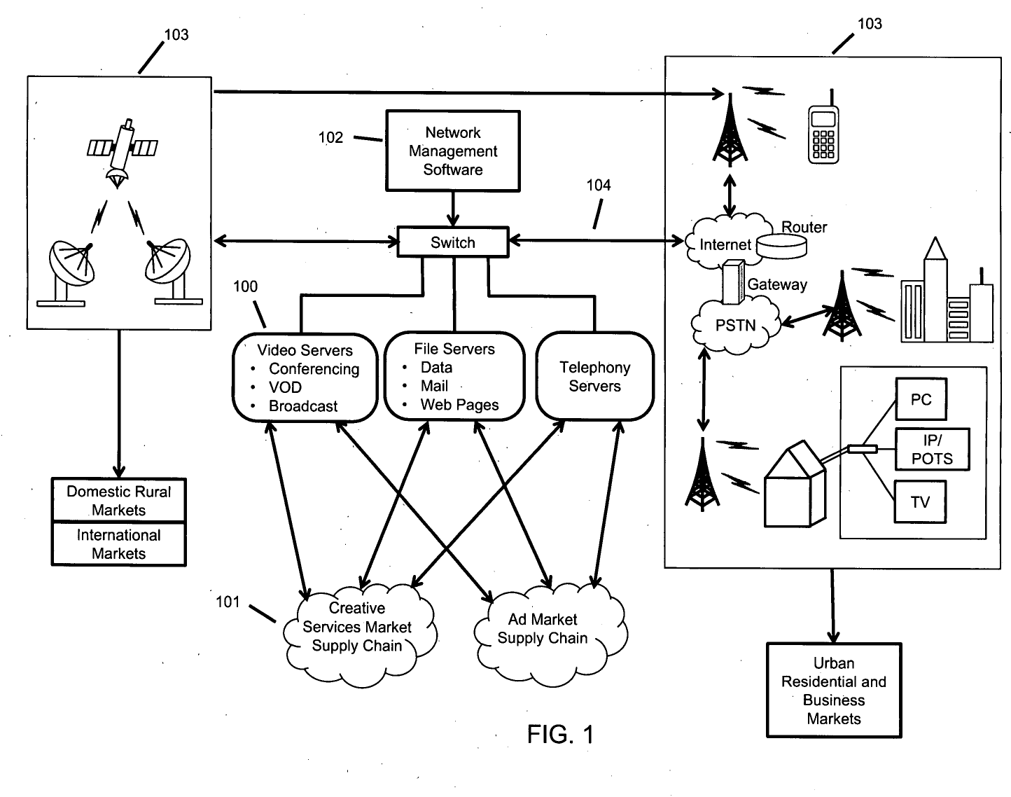

FIG. 1 illustrates the structural framework for the present invention. The invention is embodied by a business process that comprises the steps of arranging hosting for cloud-based infrastructure; installing a content management system with provisions for account management and billing; acquiring and storing content for syndication and distribution; executing affiliate agreements third party base station operators with provisions for licensing of trade names associated with the network; distributing interfaces and software development kits to base station operators and third party creative providers; and managing the network to ensure the security and integrity of the traffic passing through it and compliance with applicable FCC rules and policy goals.

In the cloud hosting step 100 in FIG. 1, the operator ensures that there will be adequate storage of capacity for the volume of content to be maintained in the network library. In the programming acquisition step 101, the operator makes arrangements for the development and terms of distribution for in-house and third party content. In the step 102 for installing a content management system, the operator virtualizes support for delivery of VOIP and multimedia services by downstream affiliated service providers. In the affiliate agreement step 103, the operator defines the terms for providing third party affiliate stations with access to network content and infrastructure for voice and multimedia services. In the step for installing interfaces between the network and base station operators 104, the operator enables the base station operators to schedule stream and downloads of network multimedia content. In the network Management step 102, the operator manages the supernetwork apparatus by implementing: (a) uplink scheduling and routing modes (PPA [0008]-[0011]); (b) downlink scheduling and routing modes (PPA [0012]-[0014]; and (c) distributing multimedia playlist content to supernetwork access points using the a metadata coding scheme described below (PPA [0015]).

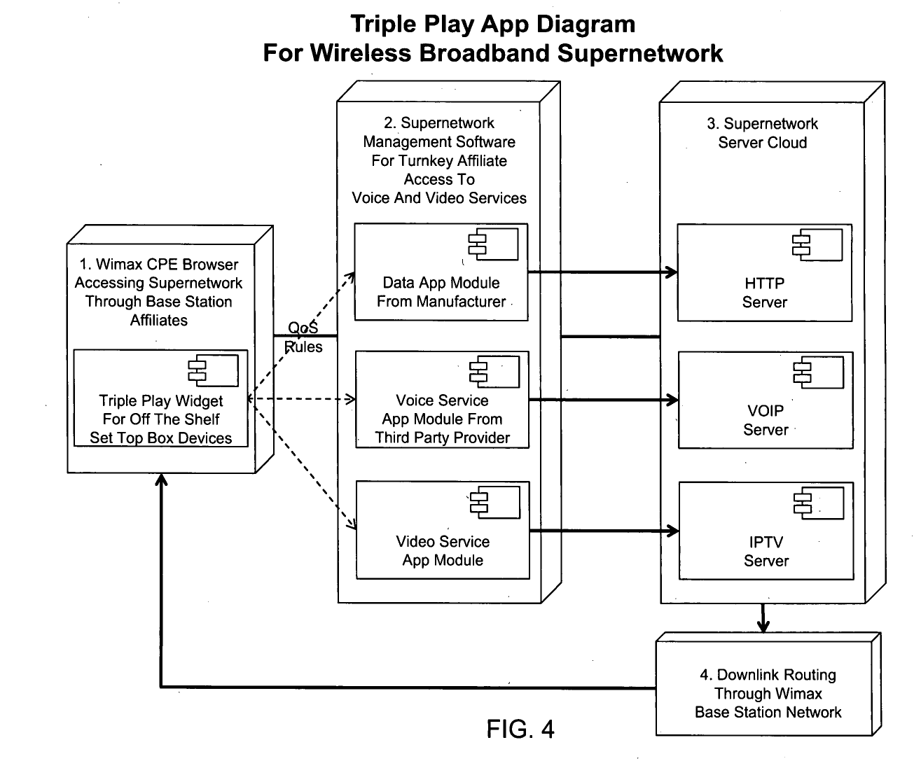

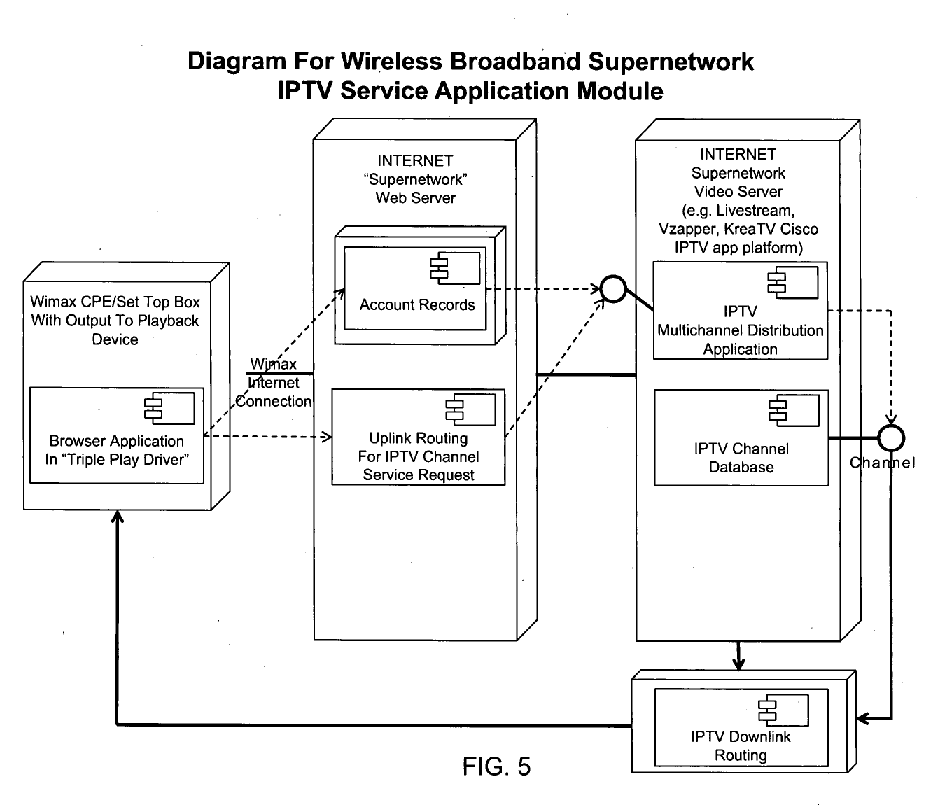

The business process of the invention has advantages for all the market participants. The advantage of the business process to the network operator is the ability to generate revenues jointly with the base station operators by distributing services and content from the cloud to the universe of subscribers receiving service from affiliate base stations. The advantage to the third party content provider is the ability to leverage alternative distribution channels for royalty income. The advantage to the base station affiliate is that the affiliate service providers, especially stand alone providers, receive the benefit of nationwide economies of scale and scope without the transaction costs and elevated risks of failure that often accompany stand alone efforts. The potential advantage to the consumer is a reduced cost for advanced services due to the lower costs of market entry for competitive service providers. The consumer also benefits from receiving periodic scheduled asynchronous downloads, or a real time point-to-multipoint process that more closely simulates the traditional broadcast audience experience. The delivery of voice, video and data services are illustrated in FIGS. 4 and 5, and further described below.

a. Data Service Offerings

The invention embodied by the above described business process, and shown in FIGS. 4 and 5, provides the means to supply data service to consumers and to businesses. In addition to the customary point to point unicast data services, specialized services exists such as delivery of point to multipoint data services over radio. The scheduled delivery or synchronization of files between a number of hosts is another service that can be provided. A content provider wanting to distribute files to large number of user can use network metadata to schedule the delivery effectively.

b. Voice Over The Internet Protocol Service Offerings

FIG. 4 illustrates a service flow for voice over the internet protocol services. Open source software development kits are available to integrate voice services into wireless broadband services in the licensed and unlicensed market segments. The specifications for this VOIP service are beyond the scope of the present application except as otherwise noted.

c. Managed Multimedia On Demand Service Offerings

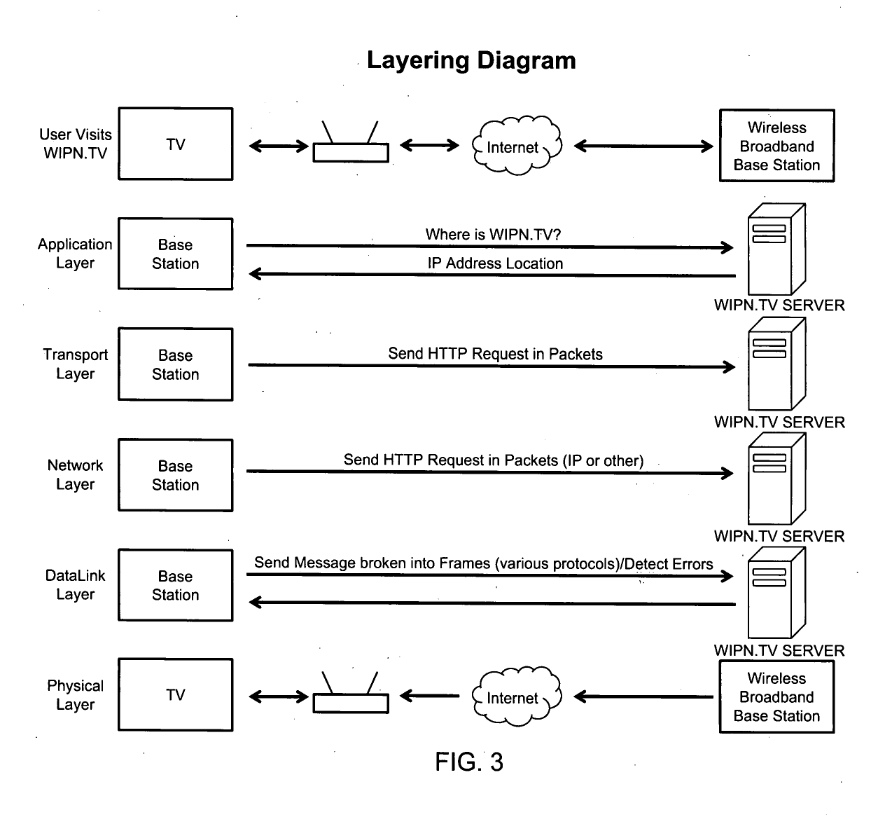

FIGS. 3 and 5 illustrates the system and process for delivery of multimedia services form the supernetwork, to the base station, and to the user. Internet media guides are a promising internet protocol media technology for the emerging 5G Cloud computing and object storage environment.“Networked Multimedia with Internet Media Guides,” Ott, et al, Computational Methods In Science and Technology,” 11(2), 129-139 (2005) (available on-line). One significant drawback for IMGs is said to be the scarcity of multicast routers and relay systems comprising the middle mile segment of the typical wireless network. Existing systems and methods are not efficient for providing access control capabilities to the multicast trees, i.e. multicast routers and their protocols, so local operators have difficulty computing charges for multicast traffic. Lewis, Peter H. “Peering Out a ‘Real Time’ Window”, 8 Feb. 1995. Retrieved 26 Aug. 2009. Nevertheless, present invention processes metadata and related program content with point-to-multipoint multicasting, to the extent feasible, to keep system-wide bandwidth usage at manageable levels.

Distance Learning. With the advent of interne-based distance learning, one of the most valuable potential uses of spectrum in the wireless broadband services is for interactive educational instruction. Point to multi-point media streaming, unicast messaging, and downloading of presentation material for distance learning are all supported by the proposed network management system. The novelty of the proposed wireless cybermedia method of network management can be seen from a comparison with methods discussed in Cherian, “From Plato to Podcast: Fifty years of Federal Involvement in Educational Technology,” (March 2009).

Streaming TV and Radio Programming Services. A programming service can use metadata to schedule audio/video streaming program content and sessions, and individual segments within those programs. SQRL metadata can appear in the form of newspaper TV guide or as an electronic program guide on television. Users select TV and radio programs manually or by SQRL setting controlling the content descriptions and the preferences of the user. IMG metadata should enable terminals to discover the availability of different media used to cover a live event, such as a concert or sporting contest. See also, “A Centralcasting Postmortem and a News Projection: Using Market Theory To Assess Alternative Local Television News Strategies (AEJMC, 2006).

Release of Multimedia Works. Release Content. Artists and Creative Service providers can use SQRL metadata to describe details of about an upcoming release. Release of content such as music and movies with known descriptions can notify a user about changes to metadata describing that content. Ott gives the example of a user seeing an announcement of a movie that will be released sometime in the next few months, and configuring his or her terminal to receive and record any trailers or promotional material as they become available.

Multiplayer Gaming. Base station operators can advertise multiplayer gaming sessions by a dedicated server or on user terminals, and either announce active multiplayer gaming sessions or advertise users' interest in participating.

d. Digital Rights Management And Monetization

The embodiment of the invention comprising the business process as described above contemplates that network operators may operate as carriers or non-carriers or as private networks, and that use of some form of digital rights management and monetization scheme will be necessary. Under the scheme contemplated, non-carrier or private network operators will both develop original content and license or purchase content from third content providers. The framework for the invention further assumes that in the latter cases, the third party multimedia content provider may elect to license content either through conventional licensing schemes, or through an alternative “open source” scheme such as that represented by one or more versions of the Creative Commons™ license or the GNU Public License. In the latter cases, a content owner may elects to license content under an open source arrangement to permit network user-audience members to create derivative works for non-commercial use according to the terms of the licensing agreement with the non-carrier or private network operator. In cases where a conventional licensing scheme involving a performance rights society is employed, the non-carrier network operator will collect and pay royalties.

### 2. Articles Of Manufacture

A further embodiment of the innovation can be represented as articles of manufacture including a software modules and hardware to interconnect the supernetwork apparatus, access points, and fixed and nomadic broadband users.

a. Software Interface

The invention consisting of articles of manufacture in the form of software interfaces perform the functions by the following means: (a) a file format and operating system wherein network data are transformed into end user data inputs (PPA [0016]-[0019]); (b) an interface for transforming network input data to output data as needed for delivery of advanced services (PPA [0020-0021]); (c) an interface between supply chain groups and the network wherein data outputs are transformed into network data inputs for distribution to base stations and end users (PPA [0025]-[0029]; (d) software interfaces connecting access points and end users wherein data inputs are transformed into data outputs as needed for advanced services (PPA [0035]-[0041]); and (e) an interface connecting network operators and access point groups wherein network data are transformed into access point data inputs for value added services to business and institutional users (PPA [0030]-[0034]. The function of these interfaces are (a) to optimize interconnections between the cloud servers, access points and hot spots, and (b) to support Quality of Service variations to minimize risks of congestion through managed on demand services and a voluntary contention based protocol implementation to coordinate managed on demand services, in the context of point-to-multipoint multimedia traffic and SQRL sessions using facilities in 3.65 GHz spectrum bands. FIGS. 3, 4 and 5 illustrate general functions performed by the software interface.

A significant embodiment of the invention comprising the above elements, and shown in FIG. 3, can be expressed as a “sequencible quantum resource locator” (SQRL) navigation data base feature for users, and a managed interne media guide gateway system for WISPs and access point operators to announce and transport content to users. The SQRL settings function empowers users and content providers to apply user generated tags their content so as to produce a self organized system for categorizing content. See e.g., Pink, “Folksonomy,” New York Times, Dec. 11, 2005. The SQRL function then assigns a numerical value from one to ten for cross references, storage, retrieval and playlisting of the content associated with the folksonomic metadata. With this SQRL sorting function, the supernetwork has the capability to pull content to the cloud supplied by third party suppliers, and then push selected content to audiences on a point to multipoint basis, subject to local quality of service parameters. The advantage to the user of the SQRL feature and dual identifiers is a more user-friendly method of multimedia programming selection. The advantage to the network and affiliate base station operators is a self generating source of demographic data for marketing and ad sales operations. See, Paskin, “Identifier Interoperability,” D-Lib Magazine, Volume 12, Number 4, (April 2006) (describing various identifier scheme proposals of the International Standards Organization.) A number of software packages, including the Molabtvx CloudWiredTV™ platform, are currently available that can be customized and configured to reduce these functions to practice.

b. Transceiver Device

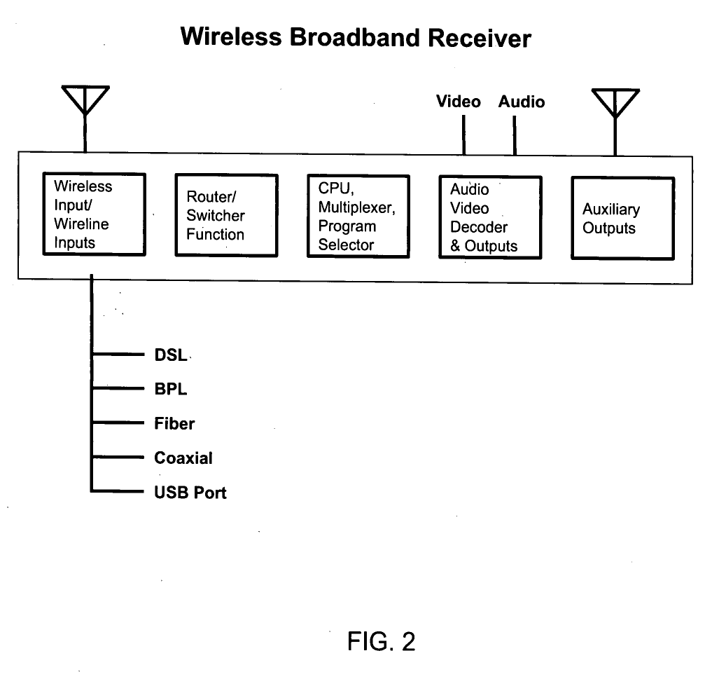

The invention is embodied by an article of manufacture in the form of a wireless transceiver to provide network access to users in fixed locations. So as not to obscure the present innovation, reference to various components of the transceiver articles of manufacture such as well known electrical structures, software routines, and hardware circuits, are omitted except as generally shown in FIG. 2 and as follows. A wireless transceiver can be developed using chipsets such as can be obtained from sources such as the TRFxxRF chipsets from Texas Instruments, or from chipsets used to manufacture the Airspan MiMax USB dongle device; and by integrating the chip set with a commercially available development kit for home media player devices, such as those that may be available from manufacturers such as Vecima Networks, RMI Alchemy™, and their competitors.

### 3. The Wireless Broadband Supernetwork Apparatus

The wireless broadband supernetwork apparatus is an embodiment of the invention that is directed to providing a means to coordinate the interplay of supply and demand using the aforementioned business process and end user devices. Specifically, the apparatus comprises a means to interconnect a centralized network operations center, the network content management system, user interfaces and a plurality of content representing the concept of the “triple play/six pack.” The apparatus also represents a means to interconnect and reach users in 3650 MHz exclusion zones. An operating system and user interfaces to support a content management system can be developed by customizing Internet Protocol television (IPTV) applications such as the Molabtvx Cloud-Wired TV™ application, an application which transmits interne protocol streams and downloads to handheld smart phone devices and other types of wireless receivers. The specification here is intended to encompass any software program presently existing or developed in the future that performs this same function. The function of the class of latter applications is to support service to users in markets where wireless broadband service in the 3.65 GHz spectrum band is available, as well as markets where wireless broadband service in the 3.65 GHz spectrum is excluded. In the latter markets, applications such as the Molabtvx Cloud-Wired TV platform give the network center the ability to reach users and audiences in the entire footprint of the United States. This feature enables content aggregators and their advertisers to compete with other methods of targeting mobile users with advertising. See e.g., Mandese, “Mobile TV Test Shows Positive Ad Results,” Media Post Nov. 8, 2010. FIGS. 1, 4 and 5 illustrate the key aspects of the supernetwork apparatus.

### 4. Best Mode of Implementation For A Wireless Cybermedia Service System

The best mode for implementing the innovation is to deploy it as a means of offering a high Quality advanced services at a low cost to a nationwide universe of fixed stations and users in and outside the 3650 MHz spectrum band. The system and processes specified support the availability of following contractual rights: (i) the right to freely send and receive lawful content over the interne including but not limited to multimedia radio, television, music, movies, voice and virtual reality services; (ii) the right to download and run lawful software applications and services of the user's choice; (iii) the right to access network operations to connect and use devices that are compatible with the network; (iv) the right to competitive delivery of good and services supplied by network service providers, application providers, service providers, and content providers; (v) the right to nondiscriminatory treatment in terms of content, applications, services and human rights; (vi) the right to use the interne to consume e-commerce services through the interne; (vii) the right to use the internet for cultural entrepreneurship; (viii) the right to use the interne for education and distance \ learning; (ix) the right to know about network management practices to determine compliance with consumer and regulatory protections; and (x) the right to privacy.

The apparatus invention also includes two methods of mitigating potential congestion due to traffic from multimedia services. In one embodiment, the invention supplements mandatory contention based protocols so local base station operators in the 3650 MHz band can coordinate the scheduling of multimedia traffic so the latter can be transmitted asynchronously in point-to-multipoint mode during off-peak service hours, when feasible. The apparatus invention can also be used on a private network basis to as a backhaul channel to offload enterprise network traffic from out of band WiFi access points in campus and conference facilities. The latter service can assist legacy carrier networks, broadcast networks, and WiFi access points at public events where those in attendance are expected to place demands in excess of the access point's normal capacity.

Generally, the invention gives subscribers of community based networks new alternatives for communicating and for participating in communications commerce. The aggregate multiplier effects of these signaling capabilities, and the tendency to underestimate the difficulty of diversifying parity of internet access, are discussed in Spence, “Signaling In Retrospect And The Information Structure of Markets,” (Nobel Prize Lecture, Dec. 8, 2001). “[t]he period in which the expansion of the network occurred, there are noticeable productivity gains. It seems very likely that the productivity gains are associated with reduced transaction costs, improved performance of markets, the ability to create new markets that were too expensive to create without the technology, and the important ability to take time and cost out of the coordination of economic activity, inside the firm and in the supply value-added chain. This is what the network, with . . . growing numbers connected to it . . . has permitted. It is a cumulative effect that we are just beginning to see.” Id. at p. 438.

Information relevant to various engineering aspects of various individual elements of the apparatus invention can be found in U.S. Pat. No. 7,660,573, and U.S. patent application No. 210020868. However, both references collectively suffer from the following limitations: (a) network specifications in the referenced patent and patent application omit references to Long Term Evolution equipment and thus appear to be limited exclusively to WIMAX™ technology equipment; (b) the references mention the possibility of introducing a technical specification for infrastructure to enable national convergence of VOIP and video mobility but it appears no specific methods are disclosed in the reference other than for data services; (c) there is no discussion of the implications of non-data traffic for contention based protocols and related issues of spectrum use coordination; (d) no method is disclosed for offering service in exclusion zones other than in unlicensed spectrum bands in the 2.0-2.4 and 5.8 GHz bands; and (e) the network management plan contains no express provisions for comply with network neutrality rules or spectrum coordination requirements.

Although the present invention has been described in considerable detail both with respect to certain preferred versions thereof, and references to similar disclosures in related fields, other versions and variations are possible as events unfold. The readers attention is directed to the provisional patent application filed prior to the present specification and which is open to the public with this specification, and the contents of which are incorporated by reference. Further, all features disclosed, in this specification may be replaced by alternative features serving the same, equivalent or similar purpose, unless expressly stated otherwise. Thus, unless expressly stated or otherwise, each feature disclosed is one example only of a generic series of equivalent or similar features.

1. A business method for coordinating supply and demand in wireless cybermedia services generally in licensed and unlicensed U.S. spectrum bands for wireless broadband services, in areas permitting use of the 3650 MHz spectrum band, and in areas where use of the 3650 MHz spectrum band is excluded, the method comprising:
(a) arranging cloud-based infrastructure to host multimedia content;
(b) installing a content management system with provisions for account management and billing;
(c) acquiring and storing content for syndication and distribution;
(d) executing affiliation agreements third party base station operators with provisions for licensing of trade names associated with the network;
(e) distributing interfaces and software development kits to base station operators and third party creative providers in the intended coverage areas; and
(f) managing the network to ensure the security and integrity of the traffic passing through it and compliance with applicable FCC rules and policy goals

2. A business method for a transceiver device to send and receive wireless cybermedia communications using software interfaces, wherein said transceiver comprises
chipsets and development kits compatible with requirements for service in the 3650 MHz spectrum band, the method comprising:
(a) selling transceiver devices to base station operators and subscribers to access a wireless broadband supernetwork apparatus;
(b) supporting the use of the transceiver device to access the apparatus; and
(c) furnishing the means for digital rights management and monetization allowing affiliate wireless broadband service providers, creative service providers and cultural entrepreneurs, to syndicate and distribute specialized multimedia content and services including radio, television, music, movies, voice and virtual reality services.

3. An article of manufactures in the form of software interfaces comprising:
(a) a file format and operating system wherein network data are transformed into end user data input;
(b) an interface for transforming network input data to output data as needed for delivery of advanced service;
(c) an interface between supply chain groups and the network wherein data outputs are transformed into network data inputs for distribution to base stations and end users;
(d) software interfaces connecting access points and end users wherein data inputs are transformed into data outputs as needed for advanced services; and
(e) an interface connecting network operators and access point groups wherein network data are transformed into access point data inputs for value added services to business and institutional users.

4. An article of manufacture in the form of an end user device to receive distributions of wireless cybermedia services, at stationary residential and campus locations, through a wireless broadband supernetwork apparatus, the latter comprising:
(a) an internet protocol content management system;
(b) orthogonal frequency division multiplex access point facilities;
(c) 3.65 GHz compatible wireless devices for mobile, nomadic and fixed users;
(d) internet-based user interfaces, specifically comprising:
(e) a process for delivering interactive multimedia service to a plurality of interconnected affiliate sites and sub-affiliate subscriber households;
f) a web-based gateway network interface enabling each affiliate access point facility to generate and transmit traffic from the network freely with autonomy of switching and addressing playlists to schedule, initiate or terminate reception of content from the programming service provider;
(g) a system and process for using user-generated metadata to process content delivered to receiver devices; and
(h) a system and process for using meta-data to connect users to the content of their choice.

5. The method of claim 4 for neutrality of network management operations comprising:
(a) an open network management process appropriate for independent wireless broadband service providers using non-line of sight wireless broadband infrastructure;
(b) a network process tailored in accordance with national policy goals to extend consumer choice, user control, competition, freedom to innovate, and freedom of expression; and
(c) a network process taking into account enhancements made possible by the evolving state of technology for offering wireless broadband service in licensed and unlicensed spectrum bands.
